(19) United States
(12) Patent Application Publication
(10) Pub. No.: US 2018/0299726 A1
(43) Pub. Date: Oct. 18, 2018

(54) DISPLAY DEVICE

(71) Applicant: Japan Display Inc., Minato-ku (JP)

(72) Inventors: Shinichiro OKA, Tokyo (JP); Shinichi KOMURA, Tokyo (JP)

(73) Assignee: Japan Display Inc., Minato-ku (JP)

(21) Appl. No.: 15/946,201

(22) Filed: Apr. 5, 2018

(30) Foreign Application Priority Data
Apr. 13, 2017 (JP) 2017-079903

(51) Int. Cl. G02F 1/1335; G02F 1/1337

(52) U.S. Cl. CPC G02F 1/133528; G02F 1/133514; G02F 1/1337; G02F 2001/133567; G02F 2001/133562; G02F 2001/133742; G02F 1/13439; G02F 2001/133538; G02F 2203/01; G02F 1/133553; G02F 2203/64; G02F 2203/66; G02F 2201/16

(57) ABSTRACT

In an embodiment, a display device comprises first and second panels, an illumination device, and first to third polarizing members. The first panel includes first and second substrates and a first liquid crystal layer between the first and second substrates. The second panel includes third and fourth substrates and a second liquid crystal layer between the third and fourth substrates. The illumination device irradiates the first substrate with light. The first polarizing member is provided between the illumination device and the first substrate. The second polarizing member is provided between the first and second liquid crystal layers. The third polarizing member faces the fourth substrate.

### CROSS-REFERENCE TO RELATED APPLICATIONS

This application is based upon and claims the benefit of priority from Japanese Patent Application No. 2017-079903, filed Apr. 13, 2017, the entire contents of which are incorporated herein by reference.

### FIELD

Embodiments described herein relate generally to a display device.

BACKGROUND

A display device in which two panels each including a liquid crystal layer are stacked is known. In this type of display device, a polarizing plate is provided between one of the panels and a backlight, on the external side of the other panel, and between the two panels. The contrast ratio of the display device is the integration of the contrast ratios of the two panels. Thus, the contrast ratio is improved in comparison with a common display device comprising only one panel.

### BRIEF DESCRIPTION OF THE DRAWINGS

FIG. 1 is an exploded perspective view schematically showing a structural example of a display device according to a first embodiment.

FIG. 2 shows schematic equivalent circuits of first and second pixels according to the first embodiment.

FIG. 3 is a schematic perspective view shown for explaining the image display by the display device according to the first embodiment.

FIG. 4 is a schematic cross-sectional view of the display device according to the first embodiment.

FIG. 5 is a cross-sectional view showing the schematic structure of a display device according to a comparison example.

FIG. 6 is a cross-sectional view showing the schematic structure of the display device according to the first embodiment.

FIG. 7 is a schematic cross-sectional view of a display device according to a second embodiment.

FIG. 8 is a schematic cross-sectional view of a display device according to a third embodiment.

FIG. 9 is a schematic cross-sectional view of a display device according to a fourth embodiment.

FIG. 10 is a schematic plan view showing the shapes of first pixels and the subpixels of second pixels.

FIG. 11 is a schematic cross-sectional view of a display device according to a fifth embodiment.

### DETAILED DESCRIPTION

In general, according to one embodiment, a display device comprises a first panel, a second panel, an illumination device, a first polarizing member, a second polarizing member and a third polarizing member. The first panel includes a first substrate, a second substrate facing the first substrate, and a first liquid crystal layer between the first substrate and the second substrate. The second panel includes a third substrate facing the second substrate, a fourth substrate facing the third substrate, and a second liquid crystal layer between the third substrate and the fourth substrate. The illumination device irradiates the first substrate with light. The first polarizing member is provided between the illumination device and the first substrate. The second polarizing member is provided between the first liquid crystal layer and the second liquid crystal layer. The third polarizing member faces the fourth substrate. In this display device, the second polarizing member is thinner than the first polarizing member and the third polarizing member. With this structure, the display quality of the display device can be improved.

Some embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In the drawings, reference numbers of continuously arranged elements equivalent or similar to each other are omitted in some cases. In addition, in the specification and drawings, structural elements which function in the same or a similar manner to those described in connection with preceding drawings are denoted by like reference numbers, detailed description thereof being omitted unless necessary.

In this specification, the phrases “a includes A, B or C”, “a includes one of A, B and C” and “a includes an element selected from a group consisting of A, B and C” do not exclude a case where a includes a plurality of combinations of A to C unless specified. Further, these phrases do not exclude a case where a includes other elements.

In this specification, the expressions “first” “second” and “third” of “the first member, the second member and the third member” are merely ordinal numbers used to explain the elements for the sake of convenience. Thus, the expression “A comprises the third member” includes a case where A does not comprise the first member and the second member unless otherwise specified.

In each embodiment, the two panels provided in the display device are assumed to be transmissive liquid crystal display panels. This display device may be used for various devices such as a smartphone, a tablet, a mobile phone, a personal computer, a television receiver, a vehicle-mounted device and a game console. Each embodiment does not prevent application of individual technical ideas disclosed in the embodiment to display devices comprising other types of display panels. Other types of display panels are assumed to include, for example, a reflective liquid crystal display panel which displays an image using external light, and a liquid crystal display panel having both a transmissive function and a reflective function.

### First Embodiment

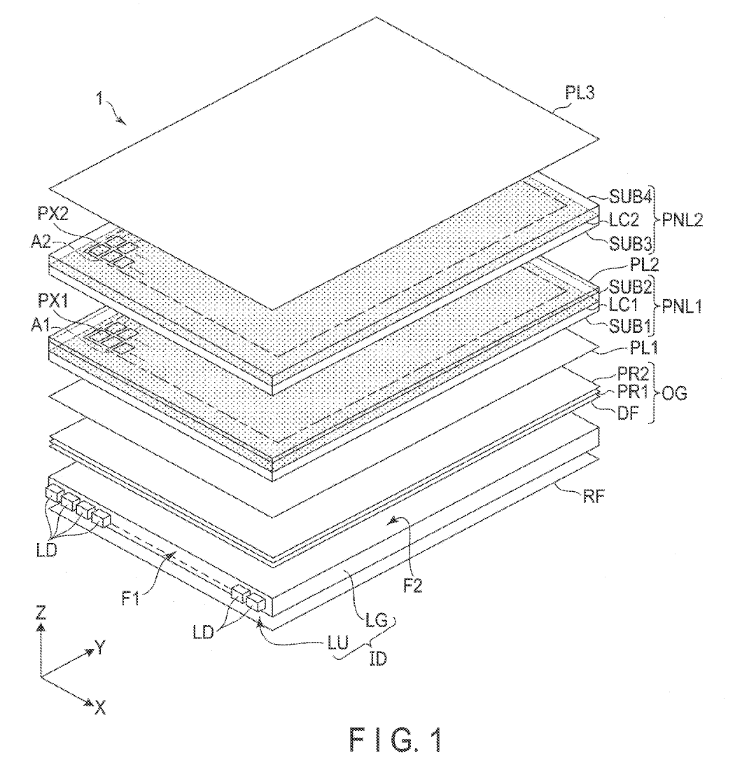

FIG. 1 is an exploded perspective view schematically showing a structural example of a display device 1. The display device 1 comprises an illumination device ID, a first panel PNL1 and a second panel PNL2. A first direction X, a second direction Y and a third direction Z are defined as shown in FIG. 1. The first, second and third directions X, Y and Z are orthogonal to one another in the present embodiment. However, they may intersect one another at an angle other than a right angle. In this disclosure, the third direction Z is referred to as “upward” or “toward the upper side”. The opposite direction of the third direction Z is referred to as “downward” or “toward the lower side”.

In the example of FIG. 1, the illumination device ID is a side-edge backlight comprising a light guide LG and a light source unit LU. However, the structure of the illumination device ID is not limited to the example of FIG. 1. Any structure may be employed as long as the illumination device ID emits light necessary for image display. For example, the illumination device ID may be a direct backlight including a light-emitting element provided under the first panel PNL1.

In the example of FIG. 1, the first panel PNL1, the second panel PNL2 and the light guide LG are formed in a rectangle comprising short sides parallel to the first direction X and long sides parallel to the second direction Y. The light guide LG, the first panel PNL1 and the second panel PNL2 are stacked in this order in the third direction Z. The shapes of the first and second panels PNL1 and PNL2 and the light guide LG are not limited to a rectangle and may be other shapes.

The light guide LG comprises an incidence surface F1 and an emission surface F2. The incidence surface F1 is equivalent to one of the pair of side surfaces of the light guide LG in the first direction X. The emission surface F2 is equivalent to, of the pair of main surfaces of the light guide LG, the main surface on the first panel PNL1 side.

The light source unit LU comprises a plurality of light-emitting diodes LD arranged in the first direction X along the incidence surface F1 of the light guide LG. Instead of the light-emitting diodes LD, the light source unit LU may comprise other types of light-emitting elements such as an organic electroluminescent element. The light emitted from the light-emitting diodes LD enters the light guide LG through the incidence surface F1, passes through the light guide LG and is emitted from the emission surface F2.

The first panel PNL1 is a transmissive liquid crystal panel, and comprises a first substrate SUB1, a second substrate SUB2 facing the first substrate SUB1, and a first liquid crystal layer LC1 provided between the first substrate SUB1 and the second substrate SUB2. The first panel PNL1 comprises a first area A1 including a plurality of first pixels PX1. The first pixels PX1 are arrayed in matrix in the first direction X and the second direction Y.

The second panel PNL2 is a transmissive liquid crystal panel, and comprises a third substrate SUB3 facing the second substrate SUB2, a fourth substrate SUB4 facing the third substrate SUB3, and a second liquid crystal layer LC2 sealed between the third substrate SUB3 and the fourth substrate SUB4. The second panel PNL2 comprises a second area A2 including a plurality of second pixels PX2. The second pixels PX2 are arrayed in matrix in the first direction X and the second direction Y.

The display device 1 further comprises a reflective sheet RF, optical sheets OG, a first polarizing member PL1, a second polarizing member PL2 and a third polarizing member PL3.

The reflective sheet RF faces the rear surface of the main surfaces of the light guide LG, in other words, the surface opposite to the emission surface F2. The reflective sheet RF returns the light leaking from the rear surface to the light guide LG. A reflective sheet facing the side surfaces of the light guide LG excluding the incidence surface F1 may be further provided.

The optical sheets OG includes, for example, a diffusion sheet DF which diffuses the light emitted from the emission surface F2 of the light guide LG, and first and second prism sheets PR1 and PR2 in which a number of prism lenses are formed.

The first polarizing member PL1 is provided between the light guide LG and the first substrate SUB1. The second polarizing member PL2 is provided between the first liquid crystal layer LC1 and the second liquid crystal layer LC2. In the example of FIG. 1, the second polarizing member PL2 is provided on the external surface of the second substrate SUB2. The third polarizing member PL3 is provided on the second panel PNL2 and faces the fourth substrate SUB4.

The first polarizing member PL1 and the third polarizing member PL3 comprise a first polarizing axis. The second polarizing member PL2 comprises a second polarizing axis orthogonal to the first polarizing axis. A crossed-Nicol relationship is established between the first polarizing member PL1 and the second polarizing member PL2 and between the second polarizing member PL2 and the third polarizing member PL3.

In the display device 1 comprising the above structure, the light emitted from the emission surface F2 of the light guide LG passes through the first polarizing member PL1 and enters the first panel PNL1.

The light entering the first panel PNL1 is linearly polarized light orthogonal to the first polarizing axis of the first polarizing member PL1. There is little change in the state of polarization of this light when the light passes an area corresponding to a first pixel PX1 in an off state (black display) in the first liquid crystal layer LC1. The light is absorbed by the second polarizing member PL2 comprising the second polarizing axis orthogonal to the first polarizing axis.

The state of polarization of the light entering the first panel PNL1 is changed when the light passes an area corresponding to a first pixel PX1 in an on state (white display) in the first liquid crystal layer LC1. The polarization of at least part of the light is orthogonal to the second polarizing axis of the second polarizing member PL2. Thus, at least part of the light passes through the second polarizing member PL2.

The light having passed through the second polarizing member PL2 enters the second panel PNL2. The light entering the second panel PNL2 is linearly polarized light orthogonal to the second polarizing axis of the second polarizing member PL2. There is little change in the state of polarization of this light when the light passes an area corresponding to a second pixel PX2 in an off state in the second liquid crystal layer LC2. The light is absorbed by the third polarizing member PL3 comprising the first polarizing axis.

The state of polarization of the light entering the second panel PNL2 is changed when the light passes an area corresponding to a second pixel PX2 in an on state in the second liquid crystal layer LC2. The polarization of at least part of the light is orthogonal to the first polarizing axis. Thus, at least part of the light passes through the third polarizing member PL3 and forms an image.

The present embodiment assumes that a normally-black mode is applied to the panels PNL1 and PNL2. However, a normally-white mode may be applied to the panels PNL1 and PNL2.

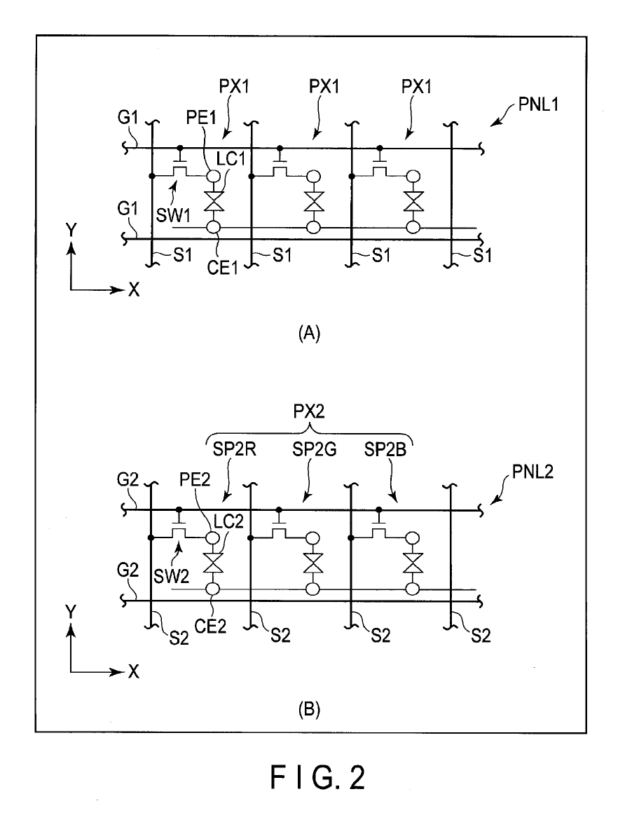

FIG. 2 shows schematic equivalent circuits of the first and second pixels PX1 and PX2.

As shown in FIG. 2(A), the first panel PNL1 comprises a plurality of scanning lines G1 extending in the first direction X, and a plurality of signal lines

S1 extending in the second direction Y. The areas defined by the scanning lines G1 and the signal lines S1 are equivalent to the first pixels PX1. Each first pixel PX1 comprises a first switching element SW1, a first pixel electrode PE1 and a first common electrode CE1. The first switching element SW1 is electrically connected to the scanning line G1, the signal line S1 and the first pixel electrode PE1. When a scanning signal is supplied to the scanning line G1, the video signal of the signal line S1 is supplied to the first pixel electrode PEI. At this time, the electric field formed between the first pixel electrode PE1 and the first common electrode CE1 affects the first liquid crystal layer LC1 (on state). In the present embodiment, the first substrate SUB1 does not comprise a color filter layer. Thus, the first pixels PX1 are monochromatic pixels displaying white or black.

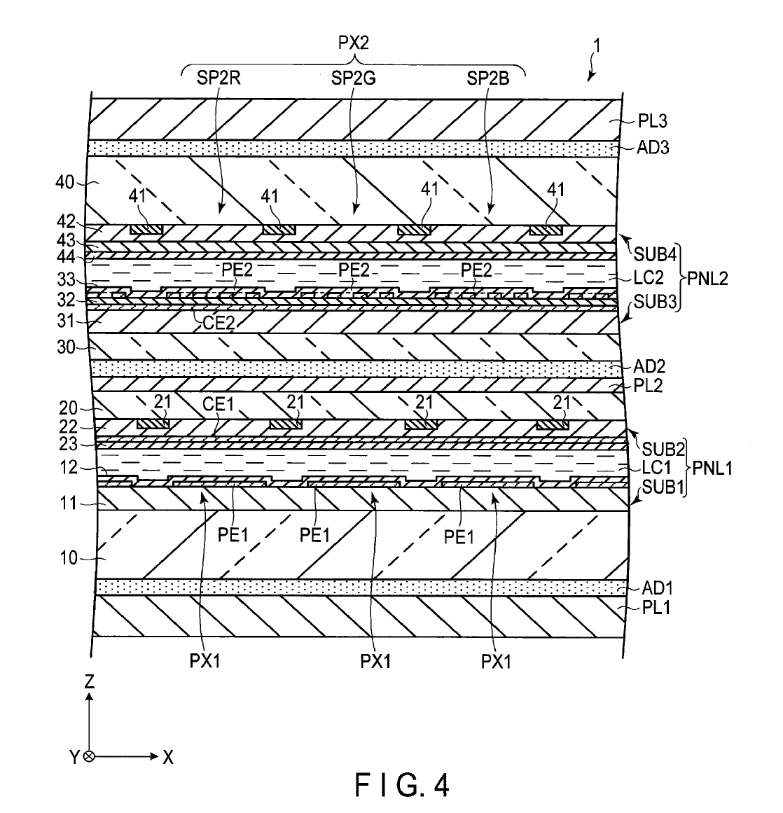

As shown in FIG. 2(B), the second panel PNL2 comprises a plurality of scanning lines G2 extending in the first direction X, and a plurality of signal lines S2 extending in the second direction Y. The areas defined by the scanning lines G2 and the signal lines S2 are equivalent to subpixels SP2. The second substrate SUB2 comprises a color filter layer 42 (see FIG. 4) including color filters corresponding to a plurality of colors. Thus, each subpixel SP2 displays a color based on a corresponding color filter. Each second pixel PX2 includes, for example, subpixels SP2R, SP2G and SP2B displaying red, green and blue, respectively. The subpixels SP2R, SP2G and SP2B are arranged in, for example, the first direction X. The types of the subpixels SP2 included in each second pixel PX2 are not limited to this example. For example, each second pixel PX2 may further include a subpixel SP2 displaying another color such as white.

Each subpixel SP2 comprises a second switching element SW2, a second pixel electrode PE2 and a second common electrode CE2. The second switching element SW2 is electrically connected to the scanning line G2, the signal line S2 and the second pixel electrode PE2. When a scanning signal is supplied to the scanning line G2, the video signal of the signal line S2 is supplied to the second pixel electrode PE2. At this time, the electric field formed between the second pixel electrode PE2 and the second common electrode CE2 affects the second liquid crystal layer LC2 (on state).

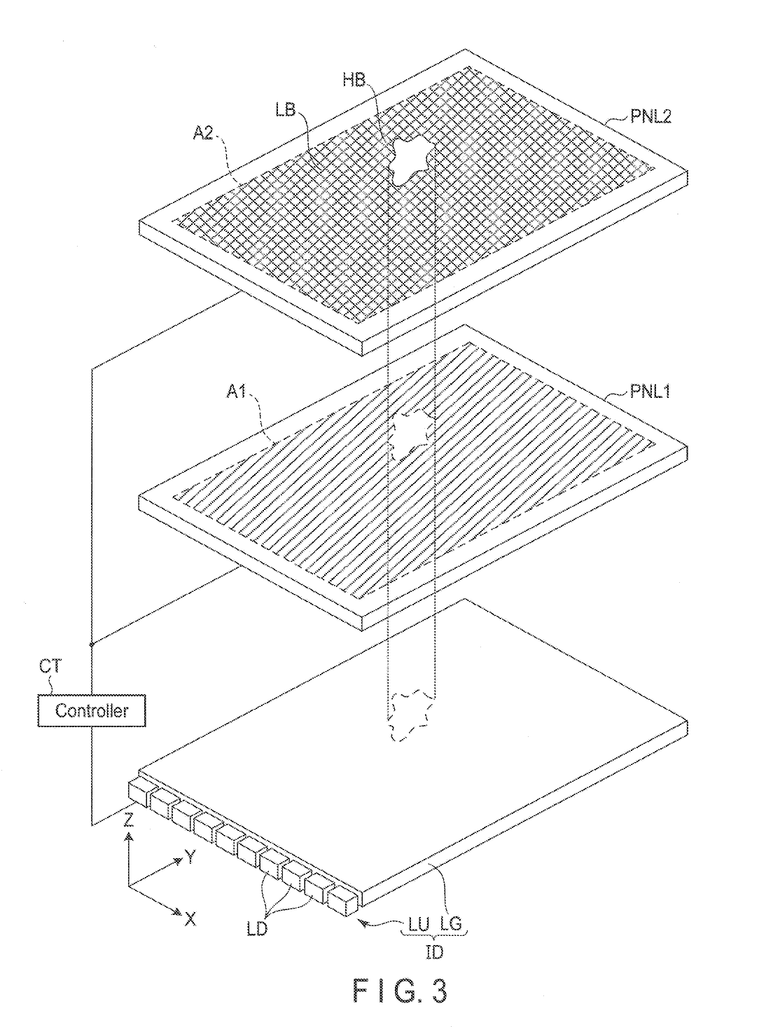

FIG. 3 is a schematic perspective view shown for explaining the image display by the display device 1. FIG. 3 shows only some of the elements constituting the display device 1.

The display device 1 comprises a controller CT. The controller CT controls the light source unit LU, the first panel PNL1 and the second panel PNL2. For example, the controller CT is structured by an IC and various circuits. The controller CT turns on or off each first pixel PX1 of the first panel PNL1 and each second pixel PX2 (subpixel SP2) of the second panel PNL2 in accordance with, for example, the image data input from outside.

For example, as shown in FIG. 3, this specification assumes that an image including a high-brightness portion HB and a low-brightness portion LB is displayed in the second area A2. In this case, in the first area A1, the controller CT turns on first pixels PX1 corresponding to the high-brightness portion HB, and turns off first pixels PX1 corresponding to the low-brightness portion LB. Further, in the second area A2, the controller CT turns on second pixels PX2 corresponding to the high-brightness portion HB, and turns off second pixels PX2 corresponding to the low-brightness portion LB.

The light emitted from the illumination device ID passes through portions corresponding to the first pixels PX1 which are turned on in the first area A1, and hardly passes through portions corresponding to the first pixels PX1 which are turned off in the first area A1. The light having passed through the first area A1 passes through the high-brightness portion HB of the second area A2, and forms an image viewed by the user.

In the present embodiment, the second panel PNL2 functions as a display panel comprising the second area (display area) A2 which displays an image, and the first panel PNL1 functions as a dimming panel which adjusts the amount of light entering the second area A2 in the first area (dimming area) A1.

In a common liquid crystal panel, even when pixels are turned off, it is difficult to completely block the light emitted from the backlight. Light slightly leaks out. As a result, it is difficult to adequately enhance the contrast ratio between the pixels which are turned on and the pixels which are turned off. In the structure of the present embodiment, two panels block light in the low-brightness portion LB. Thus, it is possible to sufficiently decrease the brightness of the low-brightness portion LB and enhance the contrast ratio of the display device 1.

FIG. 4 is a schematic cross-sectional view of the display device 1. In FIG. 4, the illustrations of the illumination device ID, the scanning lines G1 and G2, the signal lines S1 and S2, the switching elements SW1 and SW2, etc., are omitted.

The first substrate SUB1 of the first panel PNL1 comprises a first base 10, an insulating layer 11, an alignment film 12 and the first pixel electrodes PEI. The first base 10 is a rigid base such as a glass base.

The insulating layer 11 covers the upper surface of the first base 10. The first pixel electrodes PE1 are provided on the insulating layer 11. The alignment film 12 covers the first pixel electrodes PE1 and the insulating layer 11.

The second substrate SUB2 of the first panel PNL1 comprises a second base 20, a light-shielding layer 21, an overcoat layer 22, an alignment film 23 and the first common electrode CE1. The second base 20 is a resinous base formed of a resinous material such as polyimide, and has flexibility. The light-shielding layer 21 is provided under the second base 20. The light-shielding layer 21 faces, for example, the above scanning lines G1 and signal lines S1 in the third direction Z. The overcoat layer 22 covers the lower surface of the second base 20 and the light-shielding layer 21. The first common electrode CE1 is provided under the overcoat layer 22. The alignment film 23 covers the first common electrode CE1. The first liquid crystal layer LC1 is provided between the alignment film 12 and the alignment film 23.

The third substrate SUBS of the second panel PNL2 comprises a third base 30, insulating layers 31 and 32, an alignment film 33, the second pixel electrodes PE2 and the second common electrode CE2. The third base 30 is a resinous base formed of a resinous material such as polyimide, polyamide, polyester or polycarbonate, and has flexibility. The insulating layer 31 covers the upper surface of the third base 30. The second common electrode CE2 is provided on the insulating layer 31. The insulating layer 32 covers the second common electrode CE2. The second pixel electrodes PE2 are provided on the insulating layer 32. The second pixel electrodes PE2 comprise, for example, slits. The alignment film 33 covers the second pixel electrodes PE2 and the insulating layer 32.

The fourth substrate SUB4 of the second panel PNL2 comprises a fourth base 40, a light-shielding layer 41, the color filter layer 42, an overcoat layer 43 and an alignment film 44. The fourth base 40 is a rigid base such as a glass base. The light-shielding layer 41 is provided under the fourth base 40. The light-shielding layer 41 faces the above scanning lines G2 and signal lines S2 in the third direction Z. The light-shielding layer 41 faces the light-shielding layer 21 in the third direction Z. The color filter layer 42 covers the lower surface of the fourth base 40 and the light-shielding layer 41. The overcoat layer 43 covers the color filter layer 42. The color filter layer 42 includes color filters corresponding to colors corresponding to the subpixels SP2R, SP2G and SP2B. The color filter layer 42 may be provided in the third substrate SUBS. The alignment film 44 covers the overcoat layer 43. The second liquid crystal layer LC2 is provided between the alignment film 33 and the alignment film 44.

The pixel electrodes PE1 and PE2 and the common electrodes CE1 and CE2 are formed of a transparent conductive material such as indium tin oxide (ITO).

The structure of the first panel PNL1 shown in FIG. 4 is equivalent to a vertical aligned (VA) mode. In an off state, homeotropic alignment (vertical alignment) is applied to the liquid crystal molecules of the first liquid crystal layer LC1 in the third direction Z. In an on state, the liquid crystal molecules of the first liquid crystal layer LC1 are aligned in a direction intersecting the third direction Z by the vertical electric field (in the third direction Z) generated between the first pixel electrodes PE1 and the first common electrode CE1 provided in the different substrates SUB1 and SUB2. The structure of the second panel PNL2 shown in FIG. 4 is equivalent to a fringe field switching (FFS) mode, which is a type of in-plane switching (IPS) mode. In an off state, the liquid crystal molecules of the second liquid crystal layer LC2 are aligned in the alignment treatment direction of the alignment films 33 and 44. In an on state, the liquid crystal molecules of the second liquid crystal layer LC2 are aligned mainly by the lateral electric field (in a direction parallel to the X-Y plane) generated between the second pixel electrodes PE2 and the second common electrode CE2 provided in a single substrate SUBS. The mode of the panel PNL1 or PNL2 is not limited to these examples. Various modes can be applied.

In the first panel PNL1, the areas defined by the light-shielding layer 21 are equivalent to the first pixels PX1. In the second panel PNL2, the areas defined by the light-shielding layer 41 are equivalent to the subpixels SP2. In the example of FIG. 4, the second pixel PX2 includes the subpixels SP2R, SP2G and SP2B arranged in the first direction X. In the present embodiment, the subpixels SP2 face the first pixels PX1 in the third direction Z. Further, the size of each subpixel SP2 is equal to that of each first pixel PX1. For example, the width of each first pixel PX1 and each subpixel SP2 in the first direction X is 20 μm.

The display device 1 further comprises a first adhesive layer AD1, a second adhesive layer AD2 and a third adhesive layer AD3. In the present embodiment, the first and third polarizing members PL1 and PL3 are polarizing plates which are attached to the substrates SUB1 and SUB4 after the first and third polarizing members PL1 and PL3 are manufactured separately from the substrates SUB1 and SUB4. The first polarizing member PL1 is attached to the lower surface of the first base 10 via the first adhesive layer AD1. The third polarizing member PL3 is attached to the upper surface of the fourth base 40 via the third adhesive layer AD3. For example, the polarizing members PL1 and PL3 are iodine-type polarizing plates, and comprise a structure in which a polarizing layer formed of polyvinyl alcohol (PVA) containing aligned iodine is interposed between a pair of support films formed of triacetyl cellulose (TAC). However, the structure of the polarizing member PL1 or PL3 is not limited to this example.

The second polarizing member PL2 is a polarizing film formed on the upper surface of the second base 20. The polarizing film may be referred to as a coatable polarizer. For example, to form the second polarizing member PL2, a material of an alignment film is applied to the second base 20. The second base 20 is subjected to provisional burning, and is irradiated with linearly polarized ultraviolet light. Subsequently, burning is applied again. A liquid crystal material containing dye is applied to the material of an alignment film. The material is subjected to provisional burning, and is irradiated with ultraviolet light. Subsequently, burning is applied again. In this way, the dye of the liquid crystal material is aligned in a predetermined direction. It is possible to obtain the second polarizing member PL2 as a polarizing film which functions as a linear polarizing element. The second polarizing member PL2 explained here is merely an example. A polarizing film comprising any structure may be used as long as it functions as a linear polarizing element. Further, the manufacturing process is not particularly limited. In the above example, a polarizing film using a material of an alignment film is employed. However, any structure may be employed as long as the polarizing member is thin.

The second adhesive layer AD2 is interposed between the second polarizing member PL2 and the third base 30. The first panel PNL1 is attached to the second panel PNL2 via the second adhesive layer AD2. The second polarizing member PL2 may be provided at other positions as long as it is provided between the first liquid crystal layer LC1 and the second liquid crystal layer LC2. For example, the second polarizing member PL2 may be formed on the lower surface of the third base 30. In this case, the second adhesive layer AD2 is provided between the second polarizing member PL2 and the second base 20.

Now, this specification explains effects obtained from the present embodiment. Various excellent effects can be obtained from the present embodiment other than the effects explained below.

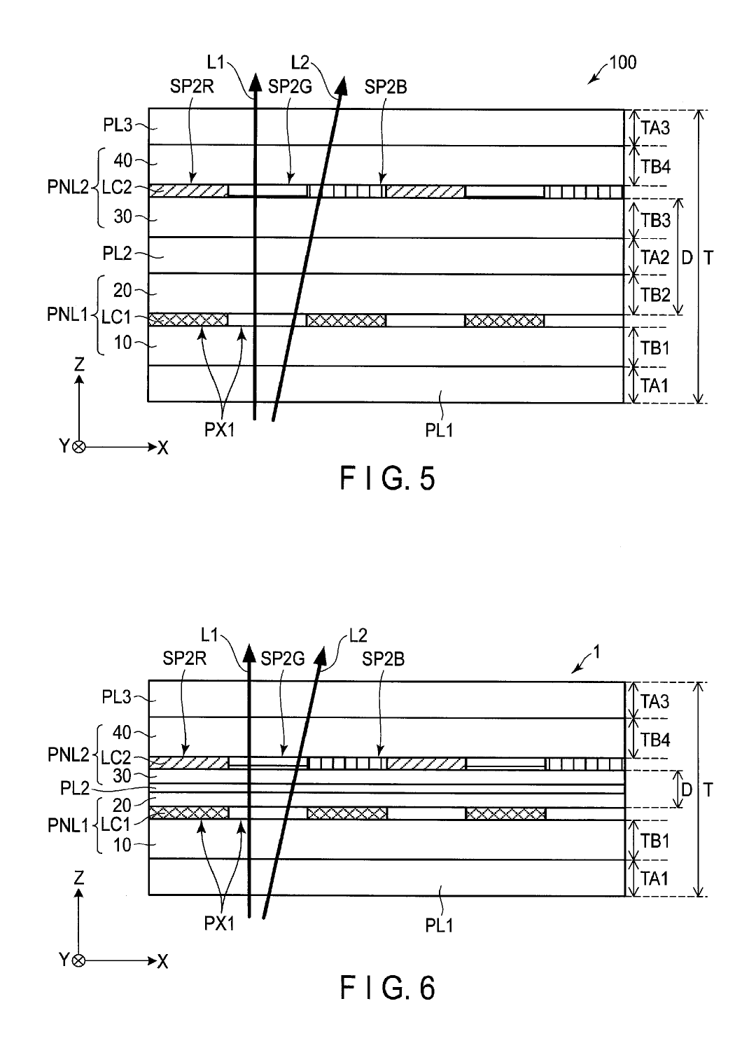

FIG. 5 shows a display device 100 according to a comparison example of the present embodiment. FIG. 5 is a cross-sectional view showing the schematic structure of the display device 100. FIG. 6 is a cross-sectional view showing the schematic structure of the display device 1 according to the present embodiment. In these figures, the elements other than the illumination device ID, the adhesive layers AD1 to AD3 and the bases 10, 20, 30 and 40 included in the substrates SUB1 to SUB4 are omitted.

In a manner similar to the display device 1, the display device 100 shown in FIG. 5 comprises the bases 10, 20, 30 and 40, the polarizing members PL1 to PL3, the liquid crystal layers LC1 and LC2, the first pixels PX1 and the subpixels SP2R, SP2G and SP2B (the second pixels PX2). The display device 100 is different from the display device 1 in terms of the following structures. The second and third bases 20 and 30 are rigid bases such as glass bases instead of resinous bases. Further, the second polarizing member PL2 is a polarizing plate instead of a polarizing film.

The thickness of the first polarizing member PL1 is defined as TA1. The thickness of the second polarizing member PL2 is defined as TA2. The thickness of the third polarizing member PL3 is defined as TA3. The thickness of the first base 10 is defined as TB1. The thickness of the second base 20 is defined as TB2. The thickness of the third base 30 is defined as TB3. The thickness of the fourth base 40 is defined as TB4. These thicknesses are thicknesses in the third direction Z.

In the display device 100 of the comparison example, the second and third bases 20 and 30 are rigid bases. In the display device 1 of the present embodiment shown in FIG. 6, the second and third bases 20 and 30 are resinous bases. In general, resinous bases can be formed so as to be thinner than rigid bases. For example, a thickness of approximately 150 μm is necessary for rigid bases while the thickness of resinous bases may be approximately 10 μm. In the display device 1, the second and third bases 20 and 30 are thinner than the first and fourth bases 10 and 40.

In the display device 100 of the comparison example of FIG. 5, the second polarizing member PL2 is a polarizing plate. In the display device 1 of the present embodiment of FIG. 6, the second polarizing member PL2 is a polarizing film. In general, polarizing plates are thicker than polarizing films. For example, at least a thickness of approximately 80 to 100 μm is necessary for polarizing plates while the thickness of polarizing films is several micrometers (for example, 2 μm).

In the display device 100 of the comparison example, as the polarizing plate is thick, distance D between the liquid crystal layer LC1 and the liquid crystal layer LC2 is great. When distance D is great, the display quality may be degraded because of parallax. As shown in FIG. 5, light L1 which passes through the panels PNL1 and PLN2 substantially parallel to the third direction Z passes through a first pixel PX1 and a subpixel SP2 (SP2G in the example of FIG. 5) corresponding to the first pixel PX1. Light L2 inclined with respect to the third direction Z could pass through a subpixel SP2 (SP2B in the example of FIG. 5) adjacent to the subpixel SP2 corresponding to the above first pixel PX1. Thus, when the screen of the display device 100 is obliquely viewed, the image may be recognized with a color different from the original color. When the display device 100 is viewed from the front side, the light-shielding layer 21 overlaps the light-shielding layer 41. However, when the display device 100 is obliquely viewed, the light-shielding layer 21 is misaligned with the light-shielding layer 41. Thus, the substantial aperture ratio of the subpixels SP2 may be decreased.

In particular, recently, display panels in which the resolution of pixels exceeds 600 ppi have been considered, as seen in head-mounted displays. In these high-definition displays, the distance between the eyes and the display panel is less. Thus, the light of the above adjacent pixel may be visually recognized through transmission. This problem very frequently occurs.

In the display device 1 of the present embodiment, as shown in FIG. 6, distance D is less. For this reason, as shown in FIG. 6, even inclined light such as light L2 easily passes through a first pixel PX1 and a subpixel SP2 corresponding to each other. Since the distance between the light-shielding layer 21 and the light-shielding layer 41 is also less, it is possible to prevent the reduction in the substantial aperture ratio of the subpixels SP2 when the display device is obliquely viewed.

For example, when thickness TB2 of the second base 20 and thickness TB3 of the third base 30 are less than or equal to 10 μm, and thickness TA2 of the second polarizing member PL2 is several micrometers, distance D can be less than or equal to 50 μm even in consideration of the other layers present between the liquid crystal layer LC1 and the liquid crystal layer LC2. When distance D is less than or equal to 50 μm, the above effect can be sufficiently obtained. Further, when distance D is less than or equal to 30 μm, the effect can be enhanced. For example, thickness TA2 (not shown in FIG. 6) in the display device 1 is preferably less than or equal to one-fifth of thickness TA1 and thickness TA3. When thickness TA2 is less than or equal to one-tenth of thickness TA1 and thickness TA3, the effect can be further enhanced.

In consideration of the above factors, thicknesses TA2, TB2 and TB3 in the display device 1 of the present embodiment are less than those thicknesses in the display device 100. Thus, in the display device 1, distance D between the liquid crystal layer LC1 and the liquid crystal layer LC2 can be less than that in the display device 100. In the display device 1, the entire thickness T can be less than that in the display device 100.

In general, the degree of polarization of iodine-type polarizing plates is approximately 99.99%. The degree of polarization of polarizing films is less than that of iodine-type polarizing plates, and is, for example, approximately 99%. While the degree of polarization of polarizing plates is several tens of thousands, the degree of polarization of polarizing films is several hundreds. The contrast ratio of a common display device which does not comprise a dimming panel is approximately 2000 at a maximum in an IPS mode, and is approximately 5000 at a maximum in a VA mode. When the above polarizing film is used as the polarizing member of a common display device, the contrast ratio of the display device cannot be sufficiently enhanced.

In the display device 1 of the present embodiment, when a polarizing film is used for the second polarizing member PL2, the contrast ratio of each of the structure of the polarizing members PL1 and PL2 and the first panel PNL1 and the structure of the polarizing members PL2 and PL3 and the second panel PNL2 is approximately several hundreds. The contrast ratio of the entire display device 1 is greater than 5000 as the integrated value. Thus, the contrast ratio can be sufficient. There is no problem even when the degree of polarization of the second polarizing member PL2 is less than that of the first polarizing member PL1 and the third polarizing member PL3.

The contrast ratio of a common display device is approximately one-tenth of the contrast ratio of the polarizing member in an IPS mode and is approximately half the contrast ratio of the polarizing member in a VA mode because of the effect of scattering in the liquid crystal layer. Thus, the contrast ratio of display devices in an IPS mode is less than that of display devices in a VA mode. However, display devices in an IPS mode have advantages in respect that a wide viewing angle can be obtained. In the present embodiment, a VA mode is applied to the first panel PNL1 which is a dimming panel, and an IPS mode is applied to the second panel PNL2 which is a display panel. Thus, it is possible to obtain the advantage of an IPS mode while the contrast ratio is enhanced with two stacked panels.

For example, to realize a display device with a high dynamic range (HDR), the contrast ratio needs to exceed the contrast ratio of a VA mode (for example, 5000). The desirable contrast ratio is, for example, greater than or equal to 10000 in the field of HDR. In the structure of the present embodiment, this contrast ratio can be realized even when a polarizing film is used for the second polarizing member PL2. As the degree of polarization and transmittance of the polarizing member has the relationship of trade-off, when the degree of polarization of the polarizing member is made high to improve the contrast ratio, the transmittance may be reduced. Thus, for example, the contrast ratio of the display device 1 should be set within a range greater than 5000 and less than or equal to 100000. It is preferable that the contrast ratio of the display device 1 be greater than or equal to 10000 and less than or equal to 100000. When the contrast ratio is within this range, the display quality can be sufficient.

For the second and third bases 20 and 30, for example, polyimide can be used as described above. Polyimide has a negative-C phase difference. Homeotropic alignment is applied to the liquid crystal molecules of the liquid crystal layer in a VA mode. The liquid crystal molecules are aligned such that the long axis is parallel to the third direction Z. The liquid crystal molecules have a positive-C phase difference. When a VA mode is applied to the first panel PNL1 like the present embodiment, the first liquid crystal layer LC1 has a positive-C phase difference. Thus, it is possible to negate the negative-C phase difference when the second and third bases 20 and 30 are formed of polyimide. The details of the compensation of a negative-C phase difference and a positive-C phase difference and homeotropic alignment are disclosed in JP 2016-4142 A and JP 2006-215221 A.

If a polarizing plate is used for the second polarizing member PL2 in the same manner as the polarizing members PL1 and PL3, a step for attaching the second polarizing member PL2 to the second base 20 or the third base 30 and a step for attaching the base to which the second polarizing member PL2 is attached to the other base are needed. When the second polarizing member PL2 is a polarizing film like the present embodiment, the second base 20 in which the second polarizing member PL2 is formed is attached to the third base 30. In this way, one attachment step can be omitted.

In the present embodiment, the first base 10 and the fourth base 40 are rigid bases. Therefore, when the first and third polarizing members PL1 and PL3 attached to the bases 10 and 40 need to be removed for repair, the work is easier than that when the bases 10 and 40 are resinous bases having flexibility.

As described above, in the present embodiment, the display quality of the display device 1 can be improved, and further, various other excellent effects can be obtained.

### Second Embodiment

A second embodiment is explained. The structures which are not particularly referred to are the same as those of the first embodiment.

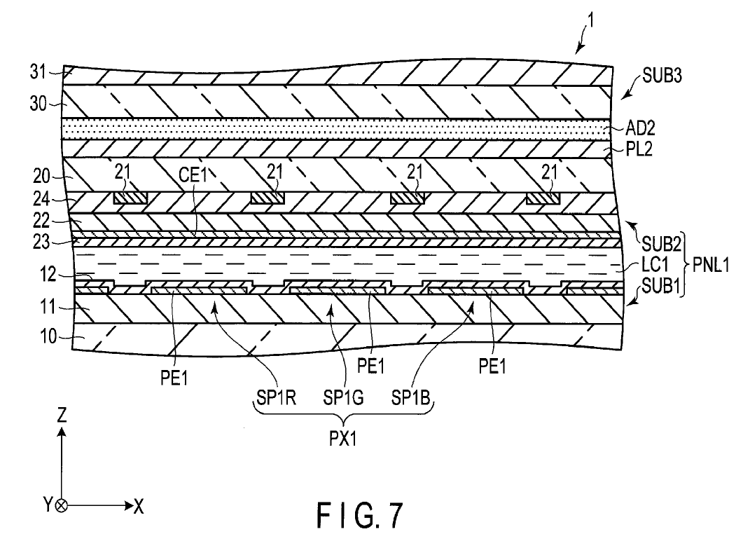

FIG. 7 is a schematic cross-sectional view of a display device 1 according to the second embodiment. The display device 1 shown in FIG. 7 is different from that of the first embodiment in respect that a first panel PNL1 comprises a color filter layer 24. The color filter layer 24 covers the lower surface of a second base 20 and a light-shielding layer 21 in a second substrate SUB2. The color filter layer 24 is covered with an overcoat layer 22. The color filter layer 24 may be provided in a first substrate SUB1.

In the present embodiment, each first pixel PX1 includes a plurality of subpixels SP1 in a manner similar to that of each second pixel PX2. In the example of FIG. 7, the first pixel PX1 includes subpixels SP1R, SP1G and SP1B displaying red, green and blue, respectively. The subpixels SP1R, SP1G and SP1B face the subpixels SP2R, SP2G and SP2B of the second pixel PX2, respectively. The types of the subpixels SP2 included in each second pixel PX2 are not limited to this example. For example, each second pixel PX2 may further include a subpixel SP2 displaying another color such as white.

In the structure of the present embodiment, effects similar to those of the first embodiment can be obtained.

### Third Embodiment

A third embodiment is explained. The structures which are not particularly referred to are the same as those of the second embodiment.

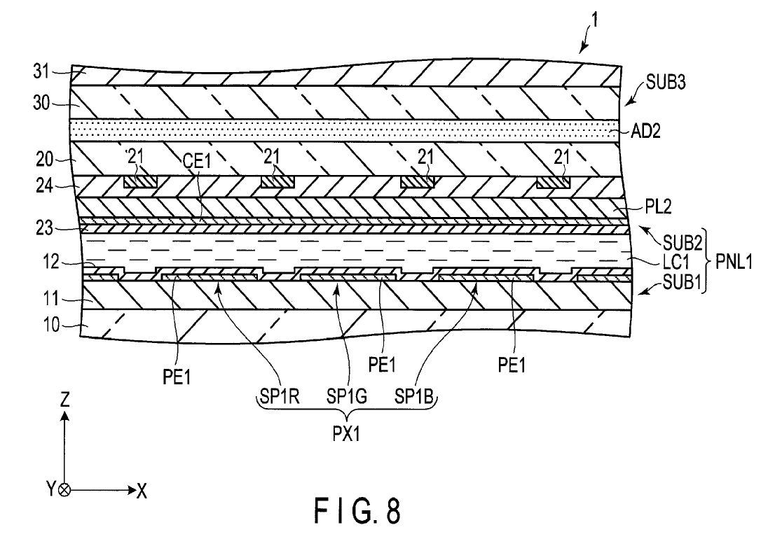

FIG. 8 is a schematic cross-sectional view of a display device 1 according to a third embodiment. In the example shown in FIG. 8, a second polarizing member PL2 which is a polarizing film is provided in a second substrate SUB2. In place of an overcoat layer 22, the second polarizing member PL2 covers a color filter layer 24. The second substrate SUB2 is attached to a third substrate SUBS via a second adhesive layer AD2. In a manner similar to that of the first embodiment, a first panel PNL1 may not comprise the color filter layer 24.

The second polarizing member PL2 may be provided at a different position in the second substrate SUB2. The second polarizing member PL2 may be provided in the third substrate SUB3. However, the third substrate SUB3 includes a second switching element SW2, etc. Thus, the third substrate SUB3 is manufactured through more processes than the second substrate SUB2. The second polarizing member PL2 is preferably provided in the second substrate SUB2 to prevent these manufacturing processes from adversely affecting the second polarizing member PL2 or prevent a process for forming the second polarizing member PL2 from adversely affecting the other layers of the second substrate SUB2.

In the structure of the present embodiment, effects similar to those of the above embodiments can be obtained.

### Fourth Embodiment

A fourth embodiment is explained. The structures which are not particularly referred to are the same as those of the first embodiment.

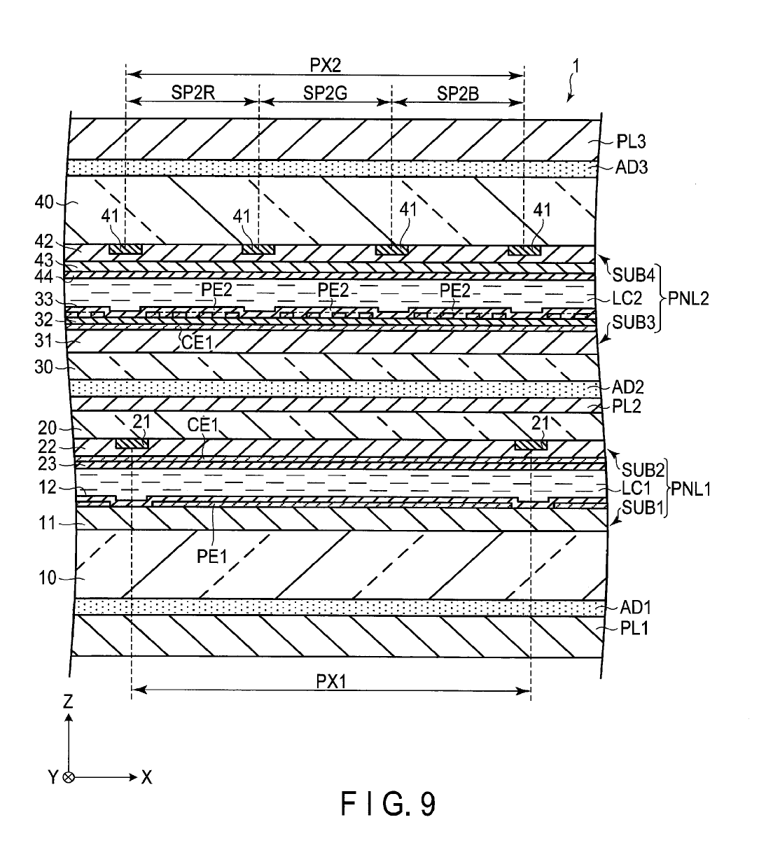

FIG. 9 is a schematic cross-sectional view of a display device 1 according to the fourth embodiment. In the example shown in FIG. 9, a first pixel PX1 is larger than each subpixel SP2 of a second pixel PX2. The first electrode PE1 of the first pixel PX1 faces a plurality of subpixels SP2 (three subpixels SP2 in the example of FIG. 9).

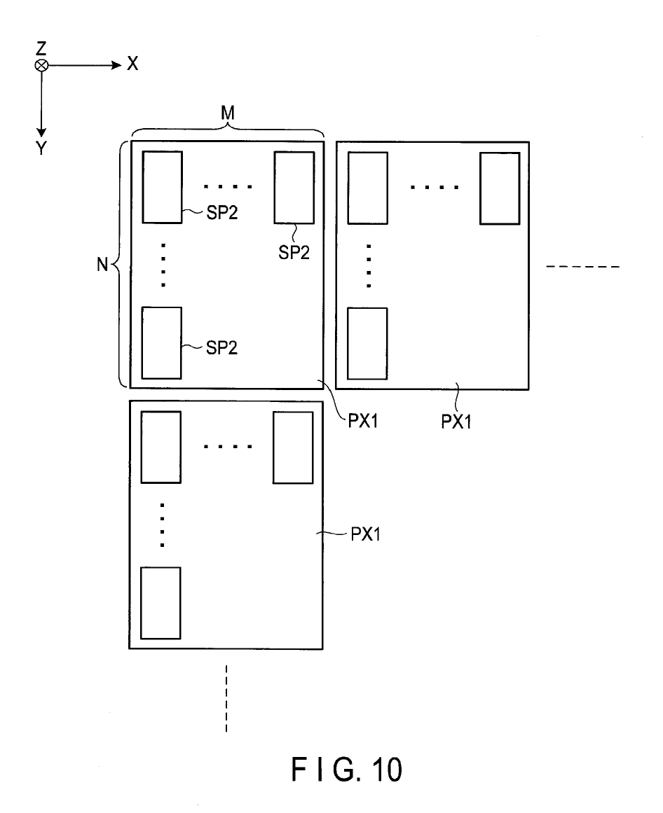

FIG. 10 is a schematic plan view showing the shapes of the first pixels PX1 and the subpixels SP2 of the second pixels PX2. Each first pixel PX1 overlaps M x N subpixels SP2. M is the number of subpixels SP2 arranged in a first direction X. N is the number of subpixels SP2 arranged in a second direction Y. Both M and N are integers, and M multiplied by N is greater than or equal to two.

In the present embodiment, the resolution of the pixels of a first panel PNL1 (the resolution related to the first pixels PX1) is less than the resolution of the pixels of a second panel PNL2 (the resolution related to the subpixels SP2).

When each first pixel PX1 overlaps a corresponding subpixel SP2 in a one-to-one relationship as shown in FIG. 4, the light having passed through a first pixel PX1 at an angle with a third direction Z may pass through the subpixel SP2 adjacent to a subpixel SP2 corresponding to the first pixel PX1 as described above. This is applicable to a case where each subpixel SP1 overlaps a corresponding subpixel SP2 in a one-to-one relationship as shown in FIG. 7 and FIG. 8.

When each first pixel PX1 overlaps a plurality of subpixels SP2, even the light passing through a first pixel PX1 at an angle with the third direction Z easily passes through a subpixel SP2 corresponding to the first pixel PX1.

As the resolution of the pixels of the first panel PNL1 is less than the resolution of the pixels of the second panel PNL2, the performance of the semiconductor of the pixel transistor (the first switching element SW1) of the first panel PNL1 may not be high. In other words, the electron mobility of the semiconductor of the pixel transistor (the first switching element SW1) of the first panel PNL1 may be less than that of the pixel transistor (the second switching element SW2) of the second panel PNL2. Specifically, the semiconductor material of the first panel PNL is amorphous silicon, and the semiconductor material of the second panel PNL2 is polysilicon. As another example, the semiconductor material of the first panel PNL1 is amorphous silicon, and the semiconductor material of the second panel PNL2 is an oxide semiconductor (indium-gallium-zinc oxide, etc.).

In the structure of the present embodiment, each subpixel SP2 overlapping a first pixel PX1 is irradiated with light having the same brightness. Thus, light leakage may occur when light having a high brightness is applied to subpixels SP2 in an off state. The brightness of the image may be decreased when light having a low brightness is applied to subpixels SP2 in an on state. In the structure of the above embodiments, the brightness of light applied to each subpixel SP2 can be individually controlled. In this way, light leakage hardly occurs, and the brightness of the image is hardly decreased. In this respect, the above embodiments are more favorable. The resolution of the pixels of the first panel PNL1 may be appropriately set to realize desired display quality in consideration of these factors.

### Fifth Embodiment

A fifth embodiment is explained. The structures which are not particularly referred to are the same as those of the first embodiment.

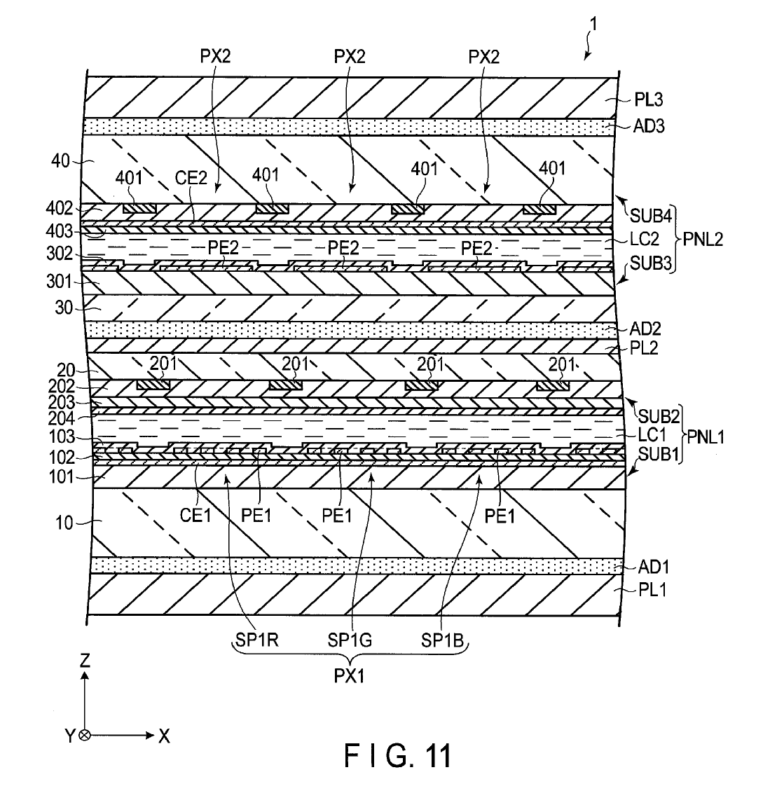

FIG. 11 is a schematic cross-sectional view of a display device 1 according to the fifth embodiment. In the present embodiment, a first panel PNL1 functions as a display panel, and a second panel PNL2 functions as a dimming panel. The second panel PNL2 adjusts the amount of light emitted from the first area (display area) A1 of the first panel PNL1 in a second area (dimming area) A2.

A first substrate SUB1 comprises insulating layers 101 and 102, an alignment film 103, first pixel electrodes PE1 and a first common electrode CE1. A second substrate SUB2 comprises a light-shielding layer 201, a color filter layer 202, an overcoat layer 203 and an alignment film 204. The shapes and layout of these elements are the same as those of the insulating layers 31 and 32, the alignment film 33, the second pixel electrodes PE2, the second common electrode CE2, the light-shielding layer 41, the color filter layer 42, the overcoat layer 43 and the alignment film 44 shown in FIG. 4.

A third substrate SUB3 comprises an insulating layer 301, an alignment film 302 and second pixel electrodes PE2. A fourth substrate SUB4 comprises a light-shielding layer 401, an overcoat layer 402, an alignment film 403 and a second common electrode CE2. The shapes and layout of these elements are the same as those of the insulating layer 11, the alignment film 12, the first pixel electrodes PE1, the light-shielding layer 21, the overcoat layer 22, the alignment film 23 and the first common electrode CE1 shown in FIG. 4.

Each first pixel PX1 of the first substrate SUB1 includes subpixels SP1R, SP1G and SP1B displaying red, green and blue, respectively. The types of the subpixels SP1 included in each first pixel PX1 are not limited to this example. For example, each first pixel PX1 may further include a subpixel SP1 displaying another color such as white.

In the example of FIG. 11, the second panel PNL2 does not comprise a color filter layer. Thus, each second pixel PX2 does not include a subpixel. As another example, the second panel PNL2 may comprise a color filter layer. In this case, each second pixel PX2 includes a plurality of subpixels corresponding to different colors.

For example, each subpixel SP1 of a first pixel PX1 faces a corresponding second pixel PX2 in a one-to-one relationship. However, in a manner similar to that of FIG. 10, each second pixel PX2 may face a plurality of subpixels SP1.

Even when, in the same manner as the present embodiment, the first panel PNL1 is a display panel, and the second panel PNL2 is a dimming panel, effects similar to those of the above embodiments can be obtained.

In the above embodiments, a VA mode is applied to the dimming panel, and an IPS mode is applied to the display panel. However, various modes can be applied to the dimming panel and the display panel, such as a twisted nematic (TN) mode, a polymer dispersed liquid crystal (PDLC) mode, an optically compensated bend (OCB) mode and an electrically controlled birefringence (ECB) mode. When a TN mode is applied to the dimming panel and the display panel, the characteristics of viewing angle can be improved by shifting the alignment treatment directions of the first and second panels PNL1 and PNL2 at 90 degrees. For example, the alignment treatment directions of the two alignment films of the first panel PNL1 may be set to directions at 45 degrees and 135 degrees with respect to the first direction X, and the alignment treatment directions of the two alignment films of the second panel PNL2 may be set to directions at 135 degrees and 225 degrees with respect to the first direction X. Rubbing treatment or optical alignment treatment may be used for the alignment treatment.

The type of the dimming panel is not limited to an active-matrix type, and may be a passive-matrix type.

In each embodiment, the second base 20 and the third base 30 are resinous bases, and the first base 10 and the fourth base 40 are rigid bases. However, at least one of the second and third bases 20 and 30 may be a rigid base. At least one of the first and fourth bases 10 and 40 may be a resinous base.

All of the display devices which may be realized by a person of ordinary skill in the art by appropriately changing the design based on the display device explained as each embodiment of the present invention fall within the scope of the invention as long as they encompass the spirit of the invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or adding or omitting a step or changing the condition of a step, all of the modifications fall within the scope of the present invention as long as they are in keeping with the spirit of the invention.

Further, other effects which may be obtained from the embodiments and are self-explanatory from the descriptions of the specification or can be arbitrarily conceived by a person of ordinary skill in the art are considered as the effects of the present invention as a matter of course.

What is claimed is:

1. A display device comprising:
a first panel including a first substrate, a second substrate facing the first substrate, and a first liquid crystal layer between the first substrate and the second substrate;
a second panel including a third substrate facing the second substrate, a fourth substrate facing the third substrate, and a second liquid crystal layer between the third substrate and the fourth substrate;
an illumination device which irradiates the first substrate with light;
a first polarizing member between the illumination device and the first substrate;
a second polarizing member between the first liquid crystal layer and the second liquid crystal layer; and
a third polarizing member facing the fourth substrate, wherein
the second polarizing member is thinner than the first polarizing member and the third polarizing member.

2. The display device of claim 1, wherein
a thickness of the second polarizing member is less than or equal to one-fifth of a thickness of the first polarizing member and the third polarizing member.

3. The display device of claim 1, wherein
the first polarizing member and the third polarizing member are polarizing plates, and
the second polarizing member is a polarizing film in which a polarizing element is provided in an alignment film.

4. The display device of claim 1, wherein
a degree of polarization of the first polarizing member and the third polarizing member is greater than a degree of polarization of the second polarizing member.

5. The display device of claim 1, wherein
the first substrate comprises a first base,
the second substrate comprises a second base,
the third substrate comprises a third base,
the fourth substrate comprises a fourth base, and
at least one of the first and fourth bases is a rigid base.

6. The display device of claim 1, wherein
at least one of the second and third bases is a resinous base thinner than the first base or the fourth base.

7. The display device of claim 6, wherein
one of the first and second panels is a display panel comprising a display area in which an image is displayed, and the other one of the first and second panels is a dimming panel which adjusts an amount of light incident on the display area or light emitted from the display area, and
homeotropic alignment is applied to liquid crystal molecules of the liquid crystal layer in the dimming panel.

8. The display device of claim 7, wherein
the liquid crystal layer has a positive-C phase difference, and
at least one of the second and third bases as the resinous base has a negative-C phase difference.

9. The display device of claim 1, wherein
one of the first and second panels is a display panel comprising a display area in which an image is displayed, and the other one of the first and second panels is a dimming panel which adjusts an amount of light incident on the display area or light emitted from the display area, and
a resolution of pixels of the dimming panel is less than a resolution of pixels of the display panel.

10. The display device of claim 9, wherein
the dimming panel comprises a plurality of first pixels,
the display panel comprises a plurality of second pixels,
one of the first pixels overlaps the M x N second pixels, and
M and N are integers greater than or equal to two.

11. The display device of claim 1, wherein
one of the first and second panels is a display panel comprising a display area in which an image is displayed, and the other one of the first and second panels is a dimming panel which adjusts an amount of light incident on the display area or light emitted from the display area,
in the display panel, both a pixel electrode and a common electrode are provided in one of a pair of substrates facing each other via the liquid crystal layer, and
in the dimming panel, a pixel electrode is provided in one of a pair of substrates facing each other via the liquid crystal layer, and a common electrode is provided in the other one of the substrates.

12. The display device of claim 1, wherein
a contrast ratio is greater than 5000 and is less than or equal to 100000.

13. The display device of claim 1, wherein
one of the first and second panels is a display panel comprising a display area in which an image is displayed, and the other one of the first and second panels is a dimming panel which adjusts an amount of light incident on the display area or light emitted from the display area,
the display panel comprises a color filter layer including color filters corresponding to a plurality of colors, respectively, and
the dimming panel does not comprise a color filter layer.

14. The display device of claim 1, wherein
the first substrate comprises a first base,
the second substrate comprises a second base, p1 the third substrate comprises a third base,
the fourth substrate comprises a fourth base, and
the second polarizing member is a polarizing film formed on a surface of the second base facing the third base.

15. The display device of claim 14, further comprising:
a first adhesive layer provided between the first polarizing member and the first base, and attaching the first polarizing member and the first panel;
a second adhesive layer provided between the second polarizing member and the third base, and attaching the first panel and the second panel; and
a third adhesive layer provided between the third polarizing member and the fourth base, and attaching the third polarizing member and the second panel.

16. The display device of claim 1, wherein
the first substrate comprises a first base,
the second substrate comprises a second base,
the third substrate comprises a third base,
the fourth substrate comprises a fourth base, and
the second polarizing member is a polarizing film formed between the second base and the first liquid crystal layer.

17. The display device of claim 16, further comprising:
a first adhesive layer provided between the first polarizing member and the first base, and attaching the first polarizing member and the first panel;
a second adhesive layer provided between the second base and the third base, and attaching the first panel and the second panel; and
a third adhesive layer provided between the third polarizing member and the fourth base, and attaching the third polarizing member and the second panel.

18. The display device of claim 16, wherein
the second substrate comprises a color filter layer including color filters corresponding to a plurality of colors, respectively, and
the second polarizing member is formed between the color filter layer and the first liquid crystal layer.

19. The display device of claim 1, wherein
a distance between the first liquid crystal layer and the second liquid crystal layer is less than or equal to 50 μm.

20. The display device of claim 1, wherein
a distance between the first liquid crystal layer and the second liquid crystal layer is less than or equal to 30 μm.
